(19) United States
(12) Patent Application Publication
(10) Pub. No.: US 2009/0015414 A1
(43) Pub. Date: Jan. 15, 2009

(54) METHOD AND APPARATUS FOR SECURE TRANSACTIONS IN A RFID INVENTORY FLOW UTILIZING ELECTRICALLY PROGRAMMABLE FUSES

(75) Inventors: Phil C. F. Paone, Rochester, MN (US); David P. Paulsen, Dodge Center, MN (US); Gregory J. Uhlmann, Rochester, MN (US); Wayne L. Vlasak, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/776,122

(22) Filed: Jul. 11, 2007

(51) Int. Cl. G08B 13/14

(52) U.S. Cl. 340/572.3

(57) ABSTRACT

A security tag adapted for use with a radiofrequency identification (RFID) system, includes: circuitry for at least one of transmitting and receiving an RFID signal, at least one one-time-programmable-read-only-memory (OTPROM) and at least one fuse (eFUSE) coupled to the OTPROM; wherein the circuitry is adapted for communication with the OTPROM and providing instructions for at least one of selectively reading the at least one fuse and selectively blowing the at least one fuse.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to security systems and particularly to systems for identifying status of articles in a stream of commerce.

2. Description of the Related Art

One of the largest security problems for the retail industry is having inventory stolen and then later returned to the store for cash. Typically the inventory is shoplifted from a store and returned at a later date for cash or store credit. In other instances, the item is stolen from a pallet along the supply chain. The item is later returned to a retail store for cash or credit.

What are needed are techniques for identifying merchandise that has been diverted from a stream of commerce and then improperly or illegally reintroduced. Preferably, the techniques are unobtrusive and provide for easy validation by the proper owners of the merchandise.

### SUMMARY OF THE INVENTION

The shortcomings of the prior art are overcome and additional advantages are provided through the provision of a security tag adapted for use with a radiofrequency identification (RFID) system, the security tag including: circuitry for at least one of transmitting and receiving an RFID signal, at least one one-time-programmable-read-only-memory (OTPROM) and at least one fuse (eFUSE) coupled to the OTPROM; wherein the circuitry is adapted for communication with the OTPROM and providing instructions for at least one of selectively reading the at least one fuse and selectively blowing the at least one fuse.

Also disclosed is a method for marking an article, the method including: coupling a security tag to the article, the security tag including circuitry for at least one of transmitting and receiving an RFID signal, at least one one-time-programmable-read-only-memory (OTPROM) and at least one fuse (eFUSE) coupled to the OTPROM; communicating with the security tag in at least one point in the stream of commerce; and at least one of selectively reading at least one fuse and selectively blowing at least one fuse in the security tag.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a security system is provided for authenticating articles in the stream of commerce. The security system includes a computer program product stored on machine readable media and including instructions for authenticating an article in the stream of commerce, the product providing instructions for: for at least one point in the stream of commerce, communicating with a security tag coupled to the article, the security tag including circuitry for at least one of transmitting and receiving an RFID signal, at least one one-time-programmable-read-only-memory (OTPROM) and at least one fuse (eFUSE) coupled to the OTPROM; and at least one of selectively reading at least one fuse and selectively blowing at least one fuse in the security tag to provide for at least one of authentication of proper flow in the stream of commerce and an indication of diversion from the stream of commerce.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates exemplary components of a security tag;

FIG. 2 illustrates one example of OTPROM of the security tag;

FIG. 3 illustrates one example of logic for inventory control;

FIG. 4 illustrates one example of a reassignment of the bits in the OTPROM;

FIG. 5 illustrates another example of logic for inventory control; and

FIG. 6 provides another exemplary logic process for inventory control.

The detailed description explains the preferred embodiments of the invention, together with advantages and features, by way of example with reference to the drawings.

### DETAILED DESCRIPTION OF THE INVENTION

The teachings herein solve the problem of determining if an item in a supply chain has somehow been removed from inventory flow and reinserted to that flow at a different point. The teachings provide for tracking of movement through the points in a supply chain, establishing a valid “chain of custody.” Apparatus providing these benefits may be included, at least in part, into a tag physically attached to the item.

In order to provide some perspective, a few terms are defined or discussed. First, the term “RFID” makes reference to the well known technology of radiofrequency identification. As is known to many consumers, RFID tags are presently incorporated with merchandise by many retailers to provide for inventory control. As a review, an RFID tag is an object that can be attached to or incorporated into another object for the purpose of identification using radio waves. Most RFID tags contain at least two parts. A first part includes an integrated circuit for storing and processing information, modulating and demodulating a radio frequency (RF) signal. The second part includes an antenna for receiving and transmitting the signal. The term “eFUSE” makes reference to an electronic fuse that may be incorporated into an integrated circuit. Once blown, the eFUSE cannot be reversed or altered. The term “OTPROM” makes reference to one time programmable read only memory circuits and designs for these circuits.

As various embodiments of RFID tags, eFUSEs, OTPROM and other components disclosed herein are known, one skilled in the art will recognize that the various functions and other aspects of the invention as discussed herein or may be devised may be employed with similar or other components. Accordingly, use of RFID tags and eFUSEs are merely illustrative and are not limiting of the teachings herein.

An apparatus for establishing an electronic chain of custody includes an OTPROM circuit adapted for use with RFID systems provided for inventory control. The OTPROM circuit includes a plurality of eFUSE components. In general, the OTPROM is attached to an article for inclusion into the stream of commerce.

Tracking of the article is performed by at least one of communication with and examination of the OTPROM. That is, as the OTPROM moves through key locations in the stream of commerce, RFID readers are used to communicate with the OTPROM and selectively blow an eFUSE. Accordingly, by using a combination of RFID readers with RFID tags including OTPROM circuits with eFUSES, an unobtrusive record is provided that authenticates proper flow of the article in the stream of commerce. That is, various RFID readers may be established at key points in the stream of commerce for communication with the RFID tag and selectively blowing an associated eFUSE.

When an article is diverted from the stream of commerce, the included RFID tag may not pass by a selected RFID reader (referred to as a “missed location”). When this is the case, each eFUSE for a missed location remains intact. Accordingly, by examination of a state for each eFUSE, one is able to determine which locations were missed in the stream of commerce. With this information, one is equipped to improve security of the articles.

One skilled in the art will recognize that a variety of embodiments may be devised for implementing RFID tags according to the teachings herein. For example, error codes and location codes could be programmed into the OTPROM.

In some embodiments, there is a separate bit in the OTPROM that is blown only if there has been an abnormal occurrence in the inventory flow. For example, the separate bit may be one of the eFUSEs representing that completion of stages in the inventory flow has been blown out of order. This indicates that the inventory item was removed from the flow at one point and re-inserted at an incorrect point. Accordingly, this design prevents someone from altering the OTPROM to make it look as if the correct flow occurred.

This “abnormal occurrence” bit may encompass multiple bits that may be associated with a type of error code representing different categories of abnormal occurrences.

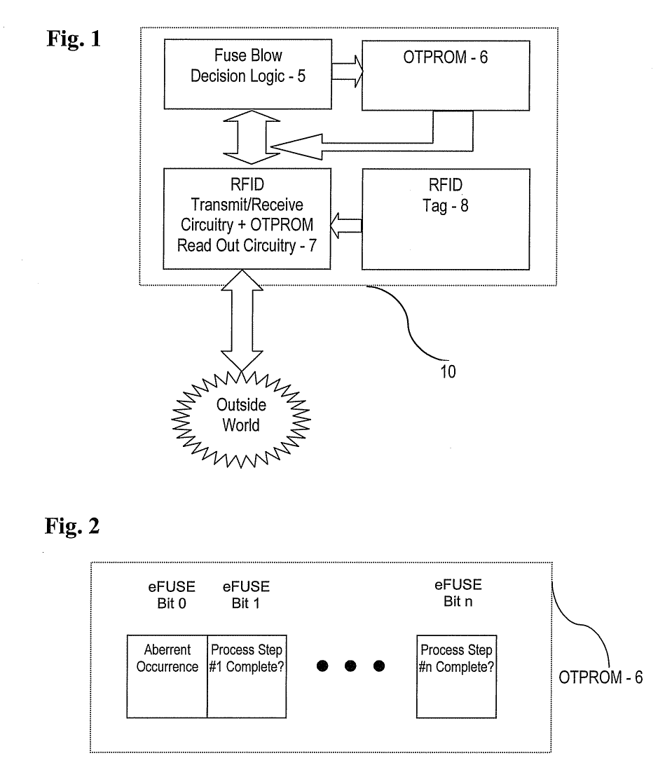

Referring now to FIG. 1, there are shown aspects of a security tag 10. The security tag 10 includes, among other things, components of an RFID tag 8, a one-time-programmable-read-only-memory (OTPROM) 6, communications circuitry 7 and a plurality of eFUSES 5. One skilled in the art of RFID circuitry will recognize that the various elements of the security tag 10 may be rearranged from this example. Accordingly, the embodiment of FIG. 1 is merely illustrative and is not limiting of the teachings herein.

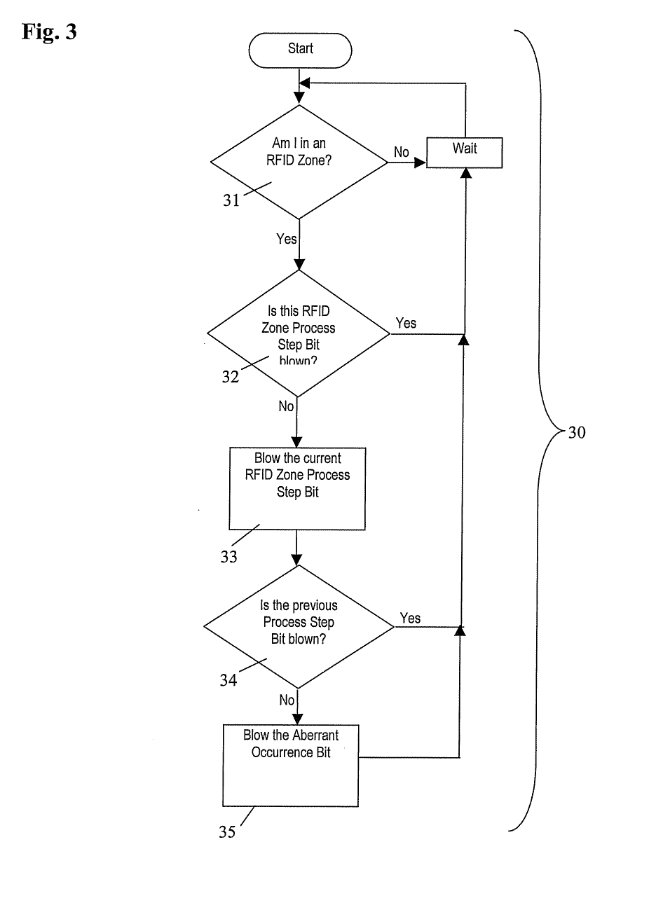

In FIG. 2, an exemplary embodiment of eFUSE assignments is provided. The assignments depicted show a stepwise assignment pattern. That is, in this embodiment, each eFUSE is blown after another, where the first eFUSE is blown in the first process step for the article. An exemplary process for testing and blowing an eFUSE (i.e., a bit associated with a process) is provided in FIG. 3.

Referring now to FIG. 3, an exemplary method for setting a process bit 30 is depicted. Setting a process bit 30 calls for testing for an RFID zone 31. If testing for an RFID zone 31 yields a positive result (i.e., the security tag 10 is located within the RFID zone), then reading of the zone process step bit 32 is performed. If the zone process step bit is not blown, the method calls for blowing the zone step bit 33. The method may also call for reading of a previous step bit 34. If the previous step bit is not blown, an aberrant occurrence has been detected. Accordingly, blowing the aberrant occurrence bit 35 is performed.

The first decision, “Am I in an RFID Zone?”, may cover the case where the article of inventory is stored in, for example, a warehouse where the entire floor is an RFID “hot zone.” In one alternative, this decision also provides for the item passing through an RFID zone, such as when entering the warehouse.

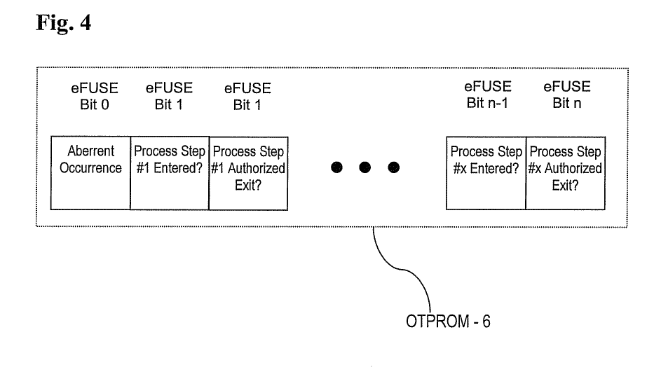

This process provides security only if the article from the inventory is carrying the security tag 10, is removed from the inventory flow and actually skips steps before returning to the flow at some later point. Another method is provided to cover such cases. In support of the another method, an alternative assignment of bits tracked in the eFUSES may be provided, such as depicted in FIG. 4.

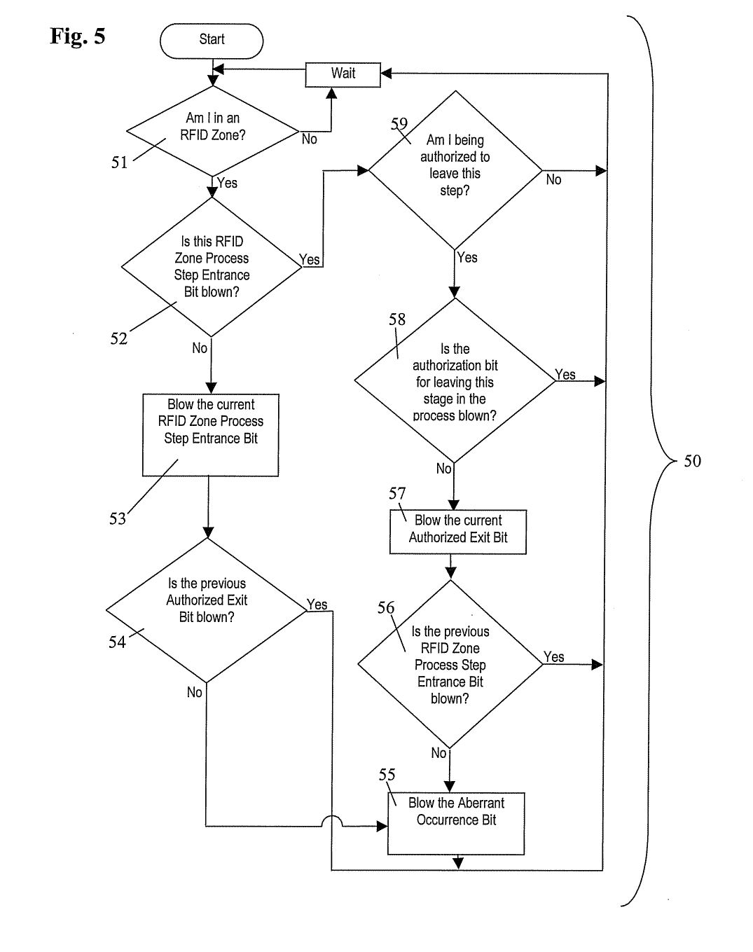

With reference to FIG. 4, bits in the OTPROM 6 are modified. In this embodiment, the logic function is modified such that an eFUSE is blown when the article enters a process stage and then another eFUSE is blown prior to the article leaving the stage. In this embodiment, the Aberrant Occurrence bit gets set if the security tag 10 enters a new stage without having been authorized to leave the previous stage. It also gets set if it somehow gets authorized to leave the wrong stage. Exemplary aspects of this alternate method are depicted in FIG. 5.

In FIG. 5, a method for setting two location process bits 50 is depicted. Setting two location specific process bits 30 calls for testing for an RFID zone 51. If testing for an RFID zone 51 yields a positive result (i.e., the security tag 10 is located within the RFID zone), then reading of the zone process step bit 52 is performed. If the zone process step bit is not blown, the method calls for blowing the zone step bit 53. The method may also call for reading of a previous step bit 54. If the previous step bit is not blown, an aberrant occurrence has been detected. Accordingly, blowing the aberrant occurrence bit 55 is performed. If reading of the zone process step bit 52 provides that the zone process step bit is blown, then authorization testing 59 is performed. In authorization testing 59, an authorization bit is tested. That is, reading of the authorization bit 58 is performed. If the authorization bit is not blown and the article is approved for leaving a process step, then blowing of the authorization bit 57 is performed. To ensure proper control of the article, reading of the previous entrance bit 56 may also be performed. If the previous entrance bit is not blown, then blowing the aberrant occurrence bit 55 is performed.

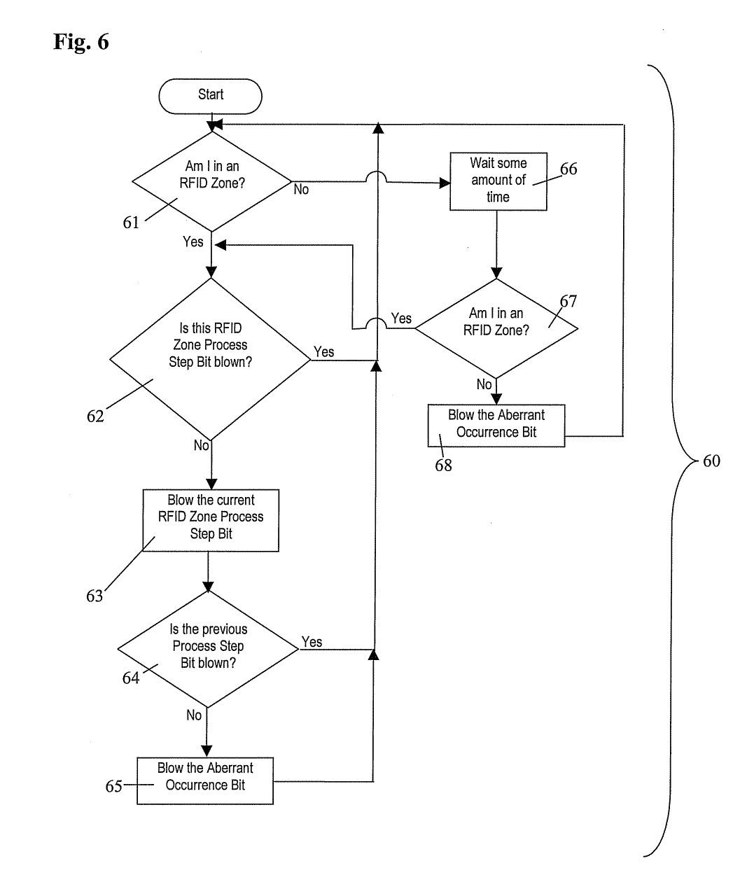

Yet another method for setting a process bit 60 is depicted in FIG. 6. The another method for setting a process bit 60 calls for testing for an RFID zone 61. If testing for an RFID zone 61 yields a positive result (i.e., the security tag 10 is located within the RFID zone), then reading of the zone process step bit 62 is performed. If the zone process step bit is not blown, the method calls for blowing the zone step bit 63. The method may also call for reading of a previous step bit 64. If the previous step bit is not blown, an aberrant occurrence has been detected. Accordingly, blowing the aberrant occurrence bit 65 is performed. If, during testing for an RFID zone 61, no RFID zone is detected, then waiting commences 66. After waiting 66 for a selected period of time, testing for an RFID zone 67 is again performed. If the RFID zone is not detected, the aberrant occurrence bit is subsequently blown 68.

In some embodiments, security may be implemented by establishing each and every step in the process as an RFID “hot zone” within which the inventory item with the security tag 10 will pass. This would include warehouse floors as well as the containers of transport trucks. In this case, the OTPROM blows a fuse when entering a zone. However, if the article having the security tag 10 exits an RFID zone, the aberrant occurrence bit is also blown. In some embodiments, a countdown timer would allow for a customizable amount of time to be outside the RFID zone. In other embodiments, multiple aberrant occurrence bits are included, such as one for each situation (i.e. skipping a step versus exiting the RFID zone).

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A security tag adapted for use with a radiofrequency identification (RFID) system, the security tag comprising:
circuitry for at least one of transmitting and receiving an RFID signal, at least one one-time-programmable-read-only-memory (OTPROM) comprised of at least one fuse (eFUSE);
wherein the circuitry is adapted for communication with the OTPROM and providing instructions for at least one of selectively reading the at least one fuse and selectively blowing the at least one fuse.

2. The security tag as in claim 1 comprising adaptations for coupling to an article to be included in the stream of commerce.

3. The security tag as in claim 1, wherein each of the at least one fuses represents a bit associated with a process step.

4. A method for marking an article, the method comprising:
coupling a security tag to the article, the security tag comprising circuitry for at least one of transmitting and receiving an RFID signal, at least one one-time-programmable-read-only-memory (OTPROM) comprised of at least one fuse (eFUSE);
communicating with the security tag in at least one point in the stream of commerce; and
at least one of selectively reading at least one fuse and selectively blowing at least one fuse in the security tag.

5. The method as in claim 4, wherein at least one of the reading and the blowing comprises providing authentication of proper flow in the stream of commerce.

6. The method as in claim 4, wherein at least one of the reading and the blowing comprises indicating diversion from the stream of commerce.

7. A computer program product stored on machine readable media and comprising instructions for authenticating an article in the stream of commerce, the product comprising instructions for:
for at least one point in the stream of commerce, communicating with a security tag coupled to the article, the security tag security tag comprising circuitry for at least one of transmitting and receiving an RFID signal, at least one one-time-programmable-read-only-memory (OTPROM) comprised of at least one fuse (eFUSE); and
at least one of selectively reading at least one fuse and selectively blowing at least one fuse in the security tag to provide for at least one of authentication of proper flow in the stream of commerce and an indication of diversion from the stream of commerce.
